(19) United States
(12) Patent Application Publication
(10) Pub. No.: US 2004/0238992 A1
(43) Pub. Date: Dec. 2, 2004

(54) Processing of waste materials

(76) Inventor: Peter Thomas, Ravenhill (GB)

Correspondence Address: CONLEY ROSE, P.C., P. O. BOX 3267, HOUSTON, TX, 77253-3267, US

(21) Appl. No.: 10/482,427

(22) PCT Filed: Jul. 3, 2002
(86) PCT No.: PCT/GB02/03063

(30) Foreign Application Priority Data
Jul. 3, 2001 (GB) 0116318.7

(51) Int. Cl. B27N 3/00

(52) U.S. Cl. 264/122; 264/109

(57) ABSTRACT

A method of processing a waste material, which method includes blending the waste material in cut, elongate, particulate or finely divided form, with an epoxy vinyl ester resin. The resin is permitted to cure, so as to form a solid body.

The present invention relates to a method of processing a waste material, and products produced from such a process.

A large variety of building elements or structural materials are known which comprise industrial or domestic waste bonded together by means of adhesive. Amongst such building elements or structural materials are breeze blocks (ashes and coal or coke bonded together with cement), chipboard (wood chips bonded together with an adhesive) and synthetic slates (slate dust bonded with adhesive).

In the thermoplastics processing industry, by-product material results from the production or processing of the thermoplastics materials. Providing an individual thermoplastic material can be kept free of contamination with other thermoplastics, it may be recycled for further processing and is therefore not waste material.

However, in view of the wide variety of thermoplastics currently used in industry, it is frequent for different types of thermoplastics waste to become mixed together; except for some special combinations there are generally significant problems in processing mixtures of different types of thermoplastics. For example, polyethylene has very different processing characteristics to those of polyethylene terephthalate (PET), both of which are common in food packaging. Furthermore, the processing characteristics of unplasticised PVC, ABS, polyethylene and PET, and other commonly used thermoplastic materials, are substantially different.

A method for improving the stiffness of such commingled plastics (mixed plastics waste) is disclosed in the Society of Plastic Engineering Annual Technical Conference 1995, Volume 53, Number 3, Pages 3752 to 3756. However, the process disclosed is a continuous process and requires the application of external heat in order to enable a moulded body to be produced. This gives rise to the disadvantage that the process cannot be carried out away from an industrial processing plant.

However, the materials produced by the methods identified above are not resistant to acids, alkalies, bleaches and organic solvents. They are therefore not suitable for use in environments where such resistance is required. In addition, such methods are not suitable for use with water materials which are not plastics materials or contain an amount of non-plastics material.

It is therefore an aim of the present invention to alleviate at least some of the disadvantages identified above.

It is a further aim of the present invention to provide a method of processing waste materials.

It is yet a further aim of the present invention to provide a building element which is substantially resistant to attack by acids, alkalies, bleaches and/or organic solvents.

Therefore, according to the present invention, there is provided a method of processing a waste material, which method includes:

a) blending the waste material in cut, elongate, particulate or finely divided form, with an epoxy vinyl ester resin; and

b) permitting the resin to cure, so as to form a solid body.

The term “waste material” as used herein denotes any material that would normally have no further economic use, or would be dumped, in for example, a landfill, if the material were not used in the method according to the present invention. The waste material may be industrial or domestic waste. The term “waste material” also covers contaminated soil or the like. The contaminants may include heavy metals, crude oil or the like.

The resulting solid body is not thermoplastic in nature; it has the characteristics of a cured thermoset material. The properties of the resulting element may be tailored depending on the nature of the waste material.

The waste material preferably includes at least one of the following: thermoplastics material (which may include AES, polystyrene (for example high impact polystyrene), unplasticised PVC, one or more polyolefins (such as polyethylene or polypropylene), polyethylene terephthalate or other polyester, or a relatively low melting polyamidey, glass, expanded polystyrene, building rubble, metals, paper, cardboard, wood, ceramics or glass fibre. The waste material may also include contaminated soil (that is soil which would have no further use if it was not used according to the present invention).

The waste material may include substantially the same material, however, this is not an essential feature of the present invention. It is envisaged that the waste material may be mixed (if the waste material is mixed, it is preferred that each waste material is processed separately) prior to blending in step a.

The waste material may be pulverised to a particle size of typically less than about 15 mm. The size of particles may be selected depending on the properties required, typically, the particle size of the waste material (which may or may not be mixed) is less than about 5 mm in diameter.

The curing in step (b) may be in a mould, alternatively the curing may take place where the body is to be used. For example, the curing may take place in a recess (such as a hole or pit in, for example, a landfill site). It is also envisaged that the curing may take place on a surface, such as a wall or a floor. In this particular embodiment, the blend in step a) is preferably applied (by painting or the like) onto the surface prior to the curing in step (b).

The blending in step (a) may be performed in a mould. Alternatively, the blending may be performed in a separate receptacle and subsequently transferred to a mould (preferably within about 30 minutes of the blending).

The blending is typically carried out by a tumbling action, or by means of a high speed mixer. Advantageously, the high speed mixer comprises a blade, paddle or the like which may be shaped to retain air into the mix during the blending in step (a). The introduction of air is advantageous when it is desirable to manufacture a lightweight moulding. Such lightweight mouldings may be suitable as, for example, pallets or the like.

The amount of vinyl ester resin present in the blend typically does not exceed about 50% by weight of the blend. It is particularly preferred that the amount of vinyl ester resin present does not exceed 20% by weight of the blend.

The vinyl ester is preferably present in a minor amount by weight of the resultant body, with the major part by weight being a matrix derived from the waste material, such that the matrix is bonded together by the cured vinyl ester.

The vinyl ester resin used in the method according to the invention is selected so as to be capable of undergoing exothermic cure, to generate a temperature of up to about 250° C. during curing in step (b).

The vinyl ester resin formulation may include a cross-linking monomer such as styrene, preferably together with a cross-linking initiator such as a peroxide.

A preferred vinyl ester resin is the resin sold under the trade mark DERAKANE by the Dow Chemical Company. In particular DERAKANE 411-350 which is a bisphenol-A epoxy resin is preferred.

Preferably the blend in step (a) includes a catalyst. It is preferred that the catalyst includes an organic peroxide.

The epoxy vinyl ester resin has a corrosion-resistant structure and may be brominated so as to be substantially fire retardant.

Epoxy vinyl ester resins advantageously are resistant to attack by acids, alkalies, bleaches and organic solvents. They also give maximum resistance to caustic alkalies and hydrochloride bleaches and have good high temperature properties.

The resultant body formed may be moulded into a range of products. Such products may include containers, board walks, piers and jetties, sea walls, flood defence barriers, paths, driveways, boat moorings, fence posts, lamp posts, swimming pools, use as retaining walls or banks in landscaping, ornamental objects, memorial stones, garden furniture, industrial flooring, ceiling tiles, prefabricated buildings, partition walls, cladding, kerb stones, paving tiles, building blocks, foundations and/or footings. It should be understood that the above list is by way of example only.

According to a further aspect of the present invention, there is provided a use of a vinyl ester resin in the reclamation of waste materials.

According to a further aspect of the present invention, there is provided a method of disposing of a waste material, which method includes blending the waste material with a vinyl ester resin and permitting the resin to cure.

According to yet a further aspect of the present invention, there is provided a moulded body which is manufactured from blending a waste material in cut, elongate, particulate or finely divided form, with an epoxy vinyl ester resin and optionally a catalyst, and permitting the resin to cure to form the moulded body.

### EXAMPLE 1

85 parts of mixed plastics, wood, cardboard and hard-core were size reduced to an average particle size of 1 mm in diameter. The waste was then mixed in a blender with 15 parts of epoxy vinyl ester resin and a catalyst. The resultant mix, which is resistant to hydrochloric, sulphuric and hydrofluoric acids, cold be applied on-site to surfaces where acid spills occur. The application is made in a similar manner to wall plaster.

### EXAMPLE 2

85 parts of dried contaminated soil particles (contaminants including heavy metals and crude oil) were drawn from the ground. 15 parts of epoxy vinyl ester resin were added to the contaminated soil on-site. The resulting “safe” soil composition was suitable for replacement in its original location.

### EXAMPLE 3

85 parts of mixed plastics, paper, wood, cardboard and hard-core were mixed in a blender with 15 parts of epoxy vinyl ester resin and a catalyst. The mixture was placed into a mould and subjected to a compressive force via means of a 10 kg weight placed on top of the mixture. The mixture was then allowed to cure (without application of external heating) for 5 minutes. The resulting moulding, in the shape of containers or bungs, would be suitable for use within industries where storage containers and similar items are required for strong acids, alkalies, bleaches and organic solvents.

1. The method of processing a waste material, comprising:
a) blending the waste material in cut, elongate, particulate or finely divided form, with an epoxy vinyl ester resin; and
b) permitting the resin to cure, so as to form a solid body.

2. The method according to claim 1, wherein the waste material includes at least one of thermoplastics material glass, expanded polystyrene, building rubble, metals, paper, cardboard, wood, ceramics or glass fibre, or contaminated soil.

3. The method according to claim, wherein the waste material is substantially the same.

4. The method according to claim 1, wherein the waste material is mixed prior to blending in step (a).

5. The method according to claim 1, wherein each waste material is processed separately prior to blending in step (a).

6. The method according to claim wherein the waste material has a particle size of less than 15 mm.

7. The method according to claim 1, wherein the curing in step (b) takes place in a mould.

8. The method according to claim 1, wherein the curing in step (b) takes place where the body is to be used.

9. The method according to claim 8, wherein the curing in step (b) takes place on a surface.

10. The method according to claim 9, wherein the blend is applied to the surface prior to the curing in step (b).

11. The method according to claim 1, wherein the blending in step (a) is performed in a mould.

12. The method according to claims 1, wherein the blending is performed in a separate receptacle and subsequently transferred to a mould.

13. The method according to claim 1, wherein the blending is carried out by a tumbling action, or by means of a high speed mixer.

14. The method according to claim 13, wherein the high speed mixer comprises a blade, or a paddle which may be shaped to retain air into the mix during the blending in step (a).

15. The method according to claim 1, wherein the amount of vinyl ester resin present in the blend typically does not exceed about 50% by weight of the blend.

16. The method according to claim 15, wherein the amount of vinyl ester resin present does not exceed 20% by weight of the blend.

17. The method according to claim 1, wherein the vinyl ester is present in a minor amount by weight of the resultant body, with the major part by weight being a matrix derived from the waste material, such that the matrix is bonded together by the cured vinyl ester.

18. The method according to claim 1, wherein the vinyl ester resin is selected so as to be capable of undergoing exothermic cure, to generate a temperature of up to about 250° C. during curing in step (b).

19. The method according to claim 1 wherein the vinyl ester resin formulation includes a cross-linking monomer.

20. The method according to claim 1 wherein the vinyl ester resin is the resin sold under the trade mark DERAKANE by the Dow Chemical Company.

21. The method according to claim 1, wherein the blend in step (a) includes a catalyst.

22. The method according to claim 21, wherein the catalyst includes an organic peroxide.

23. The method according to claim 1, wherein the epoxy vinyl ester resin has a corrosion-resistant structure.

24. The method according to claim 1, wherein the body includes at least one of containers, board walks, piers and jetties, sea walls, flood defence barriers, paths, driveways, boat moorings, fence posts, lamp posts, swimming pools, use as retaining walls or banks in landscaping, ornamental objects, memorial stones, garden furniture, industrial flooring, ceiling tiles, prefabricated buildings, partition walls, cladding, kerb stones, paving tiles, building blocks, foundations and footings.

25. Use of vinyl ester resin in the reclamation of waste materials.

26. A method of disposing of a waste material, comprising blending the waste material with a vinyl ester resin and permitting the resin to cure.

27. A moulded body, wherein the molded body is manufactured from blending a waste material in cut, elongate, particulate or finely divided form, with an epoxy vinyl ester resin, and permitting the resin to cure to form the moulded body.

28. The moulded body according to claim 27, wherein at least one of the epoxy vinyl ester resin and the waste material is blended with a catalyst.

29. The method according to claim 2, wherein the thermoplastics material comprises ABS, polystyrene, unplasticised PVC, one or more polyolefins, polyethylene terephthalate or other polyester, or a relatively low melting polyamide.

30. The method according to claim 29, wherein the polystyrene comprises high impact polystyrene.

31. The method according to claim 29, wherein the one or more polyolefins comprises polyethylene or polypropylene.

32. The method according to claim 1, wherein the waste material has a particle size of less than 5 mm.

33. The method according to claim 9, wherein the surface comprises a wall or a floor.

34. The method according to claim 19, wherein the cross-linking monomer comprises styrene.

35. The method according to claim 19, wherein the vinyl ester resin formulation further includes a cross-linking initiator.

36. The method according to claim 35, wherein the cross-linking initiator comprises a peroxide.

37. The method according to claim 23, wherein the epoxy vinyl ester resin is brominated so as to be substantially fire retardant.
